(19) United States
(12) Patent Application Publication
(10) Pub. No.: US 2024/0048223 A1
(43) Pub. Date: Feb. 8, 2024

(54) SOLAR POWERED MAST MOUNTED ANTENNA PRE-AMPLIFIER

(71) Applicant: Sony Group Corporation, Tokyo (JP)

(72) Inventors: Fred W. Ansfield, San Diego, CA (US); Peter Shintani, San Diego, CA (US)

(73) Assignee: Sony Group Corporation, Tokyo (JP)

(21) Appl. No.: 17/881,136

(22) Filed: Aug. 4, 2022

(51) Int. Cl. H04B 7/155; H02S 10/20; H02S 20/23; H02J 7/35

(52) U.S. Cl. CPC H04B 7/15535; H02S 10/20; H02S 20/23; H02J 7/35; H02J 2300/22

(57) ABSTRACT

A system to process antenna-captured OTA-transmitted RF signals for delivery to a receiver within a building includes a pre-amplifier connected to a single antenna, mounted on a mast positioned outside the building, the receiver, and a solar power unit. The solar power unit delivers power to operate the pre-amplifier. The pre-amplifier amplifies the antenna-captured signals before delivering them to the receiver at a carrier to noise ratio above an acceptable threshold, independent of where the receiver is located within the building.

### BACKGROUND

Many terrestrial locations require outdoor, mast-mounted antennas for capturing over the air (OTA) broadcast RF signals and delivering them to receivers at acceptable quality levels. The receivers may, for example, be TV sets, FM radios, AV receivers, or PVR/DVR units. A pre-amplifier is often helpful in boosting signals to be delivered by the antenna to downstream devices, but in situations where a single antenna, even a large one, is shared by multiple receivers, such as those used independently by residents of an apartment building, for example, providing a pre-amplifier close to the antenna, minimizing signal loss between the two, may be essential, for at least two reasons.

One reason is simply to allow the combination of that single antenna and pre-amplifier to provide signals of acceptable carrier to noise ratio (C/N) to multiple receivers at the same time, which involves a corresponding splitting of the captured signal. Another reason is to overcome signal losses during transmission to any receiver located at a significant distance from the pre-amplifier. Consider, for example, an extreme situation where a receiver is in a ground floor apartment at a diagonally opposite corner of the building from the rooftop corner location of the antenna, with one or more coax cables connecting the two locations. Signal loss and noise pickup during transmission through the long cable path may be significant.

However, supplying power through a building's conventional electrical network to reliably operate a pre-amplifier, given uncertainty and/or variability (at any particular time and as time changes) in the wired network topology through the building may itself be problematic, as the amounts of amplification needed may fluctuate unpredictably.

There is, therefore, a need for improved methods and systems for powering a pre-amplifier connected to an antenna—which may be considered as making up an amplified antenna unit—intended to capture, amplify and deliver OTA-transmitted RF signals to one or more receivers. These methods and systems would preferably not be susceptible to fluctuations either in the number of receivers concerned or in the network topology connecting receivers to the amplified antenna unit, and would be low cost, reliable, and environmentally benign.

### SUMMARY

The present invention includes methods and systems for providing strong RF signals, derived from OTA transmissions captured by an antenna mast-mounted outside a building, to one or more receivers. In most cases of practical interest, the one or more receivers are present within that building. In some cases, however, it is possible that one antenna may serve receivers in two or more buildings, spaced closely enough for cable losses to be acceptable.

In one embodiment, a system comprises: a pre-amplifier connected to: a single antenna, mounted on a mast positioned outside the building; a receiver; and a solar power unit; wherein the solar power unit is configured to deliver power to operate the pre-amplifier; and wherein the pre-amplifier is configured to amplify antenna-captured OTA-transmitted RF signals and deliver the amplified antenna-captured OTA-transmitted RF signals to the receiver at a carrier to noise ratio above an acceptable threshold, independent of location of the receiver within the building.

In another embodiment, a method comprises connecting a pre-amplifier to: a single antenna, mounted on a mast positioned outside the building; the receiver; and a solar power unit; delivering power from the solar power unit to the pre-amplifier; and operating the pre-amplifier to amplify antenna-captured OTA-transmitted RF signals and deliver the amplified antenna-captured OTA-transmitted RF signals to the receiver at a carrier to noise ratio above an acceptable threshold, independent of location of the receiver within the building.

A further understanding of the nature and the advantages of particular embodiments disclosed herein may be realized by reference to the remaining portions of the specification and the attached drawings.

### BRIEF DESCRIPTION OF THE DRAWINGS

FIG. 1 illustrates a system according to embodiments of the present invention.

FIG. 2 illustrates a system according to some embodiments of the present invention.

### DETAILED DESCRIPTION OF EMBODIMENTS

Described herein are embodiments of systems and methods to process antenna-captured OTA-transmitted RF signals for delivery to one or more receivers within one or more buildings in the vicinity of the signal capturing antenna.

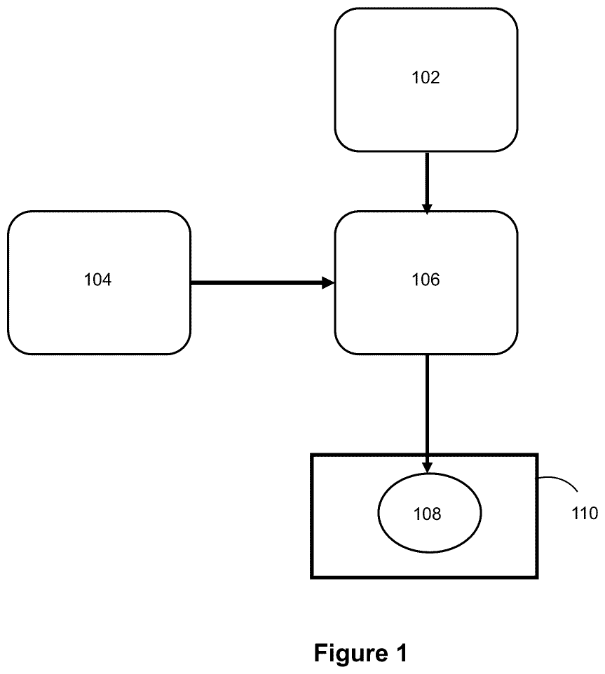

FIG. 1 shows in block diagram form a system that includes a pre-amplifier 106 connected to other components and operable according to embodiments of the present invention, to provide amplified signals to a receiver. Antenna 102, mounted on a mast positioned outside building 110 delivers the RF signals it captures from OTA transmissions to pre-amplifier 106, which is positioned in close proximity, meaning close enough for wired transmission losses between the two components to be negligible. In practice, this usually means that pre-amplifier 106 is also positioned outside building 110, as indicated in the Figure, although in some cases (not shown) it may not be. Solar power unit 104 is also connected to pre-amplifier 106, in a way that allows power generated by 104 to be delivered to operate the pre-amplifier. This interconnected arrangement allows pre-amplifier 106 to deliver the amplified antenna-captured OTA-transmitted RF signals to the receiver 108 at a carrier to noise ratio sufficient for an end user at the location of the receiver to find the reception quality acceptable, even if the signal has a long path to travel between the pre-amplifier and the receiver, with corresponding loss (which may be expressed in amplitude or intensity) and electrical noise pick-up.

Different standards specify different values of acceptable C/N. The minimum C/N required for ATSC 1.0 reception is 15.1 dB. The next generation digital broadcast in the USA, ATSC 3.0 can operate at different minimum C/N level depending upon the modulation/coding that is chosen for a particular business/use case. Often the receiver will require a minimum level of sensitivity for typical users to receive a signal. For ATSC 1.0 then, a rough signal level would be 50 dBu (decibels above 1 microvolt/m), with a C/N of approximately 15 dB or better.

While the system shown in FIG. 1 is beneficial to the end user of receiver 108, the advantages of the present invention are most marked in situations where the interconnected antenna, pre-amplifier, and solar power unit are utilized to deliver amplified antenna-captured OTA-transmitted RF signals to a plurality of receivers. As noted above, the receivers would typically, but not invariably, be located within one building.

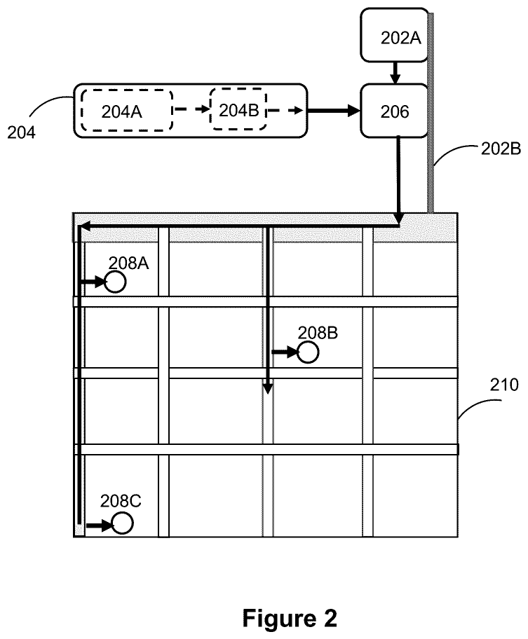

FIG. 2 schematically illustrates such a situation, where pre-amplifier 206, powered by solar power unit 204 delivers signals to three receivers 208A, 208B and 208C, located within three different living spaces in building 210. In some cases, in a block of apartments, for example, there may be many more than three receivers within a single building, to be served by an amplified antenna system, but for simplicity only three are shown in this Figure. Mast 202B, to which antenna 202A is attached, is shown explicitly in this Figure, whereas FIG. 1 simply shows an antenna 102, with the presence of a corresponding mast being implied.

The power generated by solar power unit 204 enables preamplifier 206 to deliver amplified versions of signals captured by 202A to each of the three receivers, 208A, 208B and 208C, at carrier to noise ratios that are above an acceptable threshold, independent of exactly where they are located within the building. Even receiver 208C, located at the greatest distance from preamplifier 206, is adequately served.

In the embodiment shown in FIG. 2, pre-amplifier 206 is attached to mast 202B, slightly lower down than the mast from the position where antenna 202A is attached. In other embodiments, the preamplifier may be integrated with the antenna, forming a single amplified antenna unit, attached to a mast.

In some embodiments of the present invention, the solar power unit powering the preamplifier comprises a solar panel and a rechargeable battery, with the pre-amplifier being connected directly to the rechargeable battery. FIG. 2 shows one such embodiment, with solar panel 204A feeding power into rechargeable battery 204B which in turn feeds power into preamplifier 206. The solar panel itself may be situated either remotely from the building, or in close proximity to it, and in some cases the antenna and the solar panel may even be on the same rooftop of the building. The term “close proximity” may be taken in this context to mean that the panel is close enough to the building for the power loss and cost (inherent to connecting the panel to the preamplifier) to be acceptably low.

The rechargeable battery, allowing the pre-amplifier to be powered regardless of time of day, cloud conditions etc., will typically be positioned close to the pre-amplifier to which it is connected, and may even be integrated with that pre-amplifier. In cases where the pre-amplifier is itself integrated with the antenna, a convenient and compact “doubly” integrated package may be formed.

Embodiments of the present invention offer advantages over prior art in this field, in enabling reliable, low-cost, high-quality reception of OTA-transmitted RF signals to one or more receivers served by a single, on-site or near-site, amplified antenna unit.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A system to process antenna-captured OTA-transmitted RF signals for delivery to a receiver within a building; the system comprising:
a pre-amplifier connected to:
a single antenna, mounted on a mast positioned outside the building;
the receiver; and
a solar power unit;
wherein the solar power unit is configured to deliver power to operate the pre-amplifier; and
wherein the pre-amplifier is configured to amplify antenna-captured OTA-transmitted RF signals and deliver the amplified antenna-captured OTA-transmitted RF signals to the receiver at a carrier to noise ratio above an acceptable threshold, independent of where the receiver is located within the building.

2. The system of claim 1,
wherein the pre-amplifier is connected to a plurality of receivers at a corresponding plurality of locations within the building; and
wherein the pre-amplifier is configured to deliver the amplified antenna-captured OTA-transmitted RF signals to the plurality of receivers at carrier to noise ratios above the acceptable threshold, independent of the locations of the receivers.

3. The system of claim 1, wherein the pre-amplifier is attached to the mast.

4. The system of claim 1, wherein the pre-amplifier is integrated with the antenna forming a single amplified antenna unit attached to the mast.

5. The system of claim 1, wherein the solar power unit comprises a solar panel and a rechargeable battery.

6. The system of claim 5, wherein the solar panel is situated remotely from the building.

7. The system of claim 5, wherein the solar panel is situated in close proximity to the building.

8. The system of claim 7, wherein the solar panel is mounted on a rooftop of the building.

9. The system of claim 5, wherein the rechargeable battery is integrated with an amplified antenna unit comprising the pre-amplifier integrated with the antenna.

10. A method to process antenna-captured OTA-transmitted RF signals for delivery to a receiver within a building; the method comprising:
connecting a pre-amplifier to:
a single antenna, mounted on a mast positioned outside the building;
the receiver; and
a solar power unit;
delivering power from the solar power unit to the pre-amplifier; and
operating the pre-amplifier to amplify antenna-captured OTA-transmitted RF signals and deliver the amplified antenna-captured OTA-transmitted RF signals to the receiver at a carrier to noise ratio above an acceptable threshold, independent of where the receiver is located within the building.

11. The method of claim 10, additionally comprising:
connecting the pre-amplifier to a plurality of receivers at a corresponding plurality of locations within the building; and
delivering the amplified antenna-captured OTA-transmitted RF signals to the plurality of receivers at carrier to noise ratios above an acceptable threshold, independent of the locations of the plurality of receivers.

12. The method of claim 10, wherein the pre-amplifier is attached to the mast.

13. The method of claim 11, wherein the pre-amplifier is integrated with the antenna in a unit attached to the mast.

14. The method of claim 9, wherein the solar power unit comprises a solar panel and a rechargeable battery.

15. The method of claim 14, wherein the solar panel is situated remotely from the mast.

16. The method of claim 14, wherein the solar panel is situated in close proximity to the building.

17. The method of claim 14, wherein the solar panel is mounted on a rooftop of the building.
